(19) United States
(12) Patent Application Publication
(10) Pub. No.: US 2024/0369795 A1
(43) Pub. Date: Nov. 7, 2024

(54) CABLE ACCESS TERMINAL CONFIGURED TO PERMIT ACCESS TO A COMPONENT IN THE TERMINAL AND PREVENT ACCESS TO ANOTHER COMPONENT IN THE TERMINAL

(71) Applicant: PPC BROADBAND, INC., East Syracuse, NY (US)

(72) Inventors: Sandeep PULIYANKULANGARA, Ernakulam (IN); Afzal V. ABDULSALAM, Pukkattupady (IN); Boby ANTONY, Kochi (IN)

(73) Assignee: PPC BROADBAND, INC., East Syracuse, NY (US)

(21) Appl. No.: 18/654,381

(22) Filed: May 3, 2024

Related U.S. Application Data
(60) Provisional application No. 63/523,962, filed on Jun. 29, 2023.

(30) Foreign Application Priority Data
May 5, 2023 (IN) 202321032013

(51) Int. Cl. G02B 6/44

(52) U.S. Cl. CPC G02B 6/4471

(57) ABSTRACT

A cable access terminal includes: a base; a moving portion attached to the base; and a cover that is configured to prevent access to an upper area of the moving portion. The moving portion may be configured to prevent access to a base area in a closed position; the cover may be configured to prevent access to a first side of an adapter as a result of the cover being secured to the moving portion; and the moving portion may be structurally configured to permit access to the first side of the adapter and to the base area when the fastener is removed and to prevent access to the first side of the adapter and to the base area, while permitting access to the second side of the adapter, when the fastener is in place, so as to provide only limited access to users unauthorized to access the base area.

### CROSS-REFERENCE TO RELATED APPLICATION

This application claims the benefit of India Provisional Patent Application No. 202321032013, filed May 5, 2023, and U.S. Provisional Application No. 63/523,962 filed Jun. 29, 2023, which are currently pending, the disclosures of which are hereby incorporated by reference herein in their entireties.

### BACKGROUND

The present disclosure relates generally to telecommunications access terminals and, in particular, to a telecommunications access terminal having a compact size and a cable management system.

Some conventional cable access terminals include fiber optic adapters, cable lugs, cable spooling, and/or other cable management, splitting, and/or splicing areas. A technician or user generally needs to access a component in the terminal, for example, a port of an adapter. However, the technician or user may not be authorized to access other components in the terminal. Such conventional terminals do not prevent an unauthorized technician or user from accessing certain components in the terminal.

In some situations, it may be desirable to limit access to certain areas of an access terminal while allowing access to other areas of the terminal such that a technician or user is permitted to access a certain component, but is prevented from accessing another component that the technician or user is not authorized to access. It may be desirable to provide a telecommunications access terminal that is compact in size and has such partial limited access.

### SUMMARY

The present disclosure provides a much needed compact system for providing a technician access to all areas of an access terminal, while limiting access by other users to only certain areas of the access terminal.

Embodiments provide a cable access terminal including: a base portion that may be configured to define a base area; a pivoting portion that may be structurally configured to be attached to the base portion by a hinge portion such that the pivoting portion is structurally configured to pivot relative to the base portion while remaining attached to the base portion; a fastener that may be structurally configured to secure the pivoting portion to the base portion in a closed position; and a pivoting portion upper cover portion that may be structurally configured to prevent access to an upper area of the pivoting portion. The pivoting portion may be structurally configured to pivot between an open position and the closed position. The pivoting portion may be structurally configured to prevent access to the base area in the closed position. The pivoting portion may be structurally configured to receive an adapter portion. The pivoting portion upper cover portion may be structurally configured to prevent access to a first side of the adapter portion as a result of the pivoting portion upper cover portion being secured to the pivoting portion by the fastener. The pivoting portion may be structurally configured to permit access to the first side of the adapter portion and to the base area when the fastener is removed and to prevent access to the first side of the adapter portion and to the base area, while permitting access to the second side of the adapter portion, when the fastener is in place so as to provide only limited access to users unauthorized to access a component in the base area.

In embodiments, the pivoting portion upper cover portion may be configured to slidingly engage the pivoting portion.

In embodiments, the pivoting portion may be structurally configured to receive an adapter plate, the adapter plate may be configured to receive the adapter portion, and the adapter portion may be configured to receive an optical fiber connector.

In embodiments, the upper area may be structurally configured to receive a splitter.

In embodiments, the splitter may comprise an optical fiber splitter.

In embodiments, the cable access terminal may further comprise a cable securing portion covering portion that may be configured to extend from the pivoting portion and cover a cable securing portion located adjacent the cable access terminal.

In embodiments, the lower side of the pivoting portion may comprise a splice holder.

In embodiments, the cable access terminal may further comprise a pivoting portion lower cover portion that may be structurally configured to cover a lower side of the pivoting portion, the lower side being opposite to the upper area.

In embodiments, the pivoting portion lower cover portion may be configured to be transparent to provide visual inspection of the splice holder.

In embodiments, the base portion may comprise cable management structure that is structurally configured to restrain a cable.

In embodiments, the pivoting portion may be configured to prevent access to the cable management structure when the pivoting portion is in the closed position.

Embodiments provide a cable access terminal including: a base portion that may be configured to define a base area; a moving portion that may be structurally configured to be attached to the base portion by a connection portion such that the moving portion may be structurally configured to move relative to the base portion while remaining attached to the base portion; a fastener that may be structurally configured to secure the moving portion to the base portion in a closed position; and a moving portion upper cover portion that may be structurally configured to prevent access to an upper area of the moving portion. The moving portion may be structurally configured to prevent access to the base area in the closed position; the moving portion upper cover portion may be structurally configured to prevent access to a first side of an adapter portion as a result of the moving portion upper cover portion being secured to the moving portion by the fastener; and the moving portion may be structurally configured to permit access to the first side of the adapter portion and to the base area when the fastener is removed and to prevent access to the first side of the adapter portion and to the base area, while permitting access to the second side of the adapter portion, when the fastener is in place, so as to provide only limited access to users unauthorized to access a component in the base area.

In embodiments, the moving portion may be structurally configured to pivot between an open position and the closed position.

In embodiments, the moving portion may be structurally configured to receive the adapter portion.

In embodiments, the moving portion may be structurally configured to receive an adapter plate, the adapter plate may be configured to receive the adapter portion, and the adapter portion may be configured to receive an optical fiber connector.

In embodiments, the cable access terminal may further comprise a cable securing portion covering portion that may be configured to extend from the moving portion and cover a cable securing portion located adjacent the cable access terminal.

Embodiments provide a cable access terminal including: a base portion; a moving portion that may be structurally configured to be movingly attached to the base portion; and a moving portion upper cover portion that may be structurally configured to prevent access to an upper area of the moving portion. The moving portion may be structurally configured to prevent access to a base area in a closed position; the moving portion upper cover portion may be structurally configured to prevent access to a first side of an adapter portion as a result of the moving portion upper cover portion being secured to the moving portion; and the moving portion may be structurally configured to permit access to the first side of the adapter portion and to the base area when the fastener is removed and to prevent access to the first side of the adapter portion and to the base area, while permitting access to the second side of the adapter portion, when the fastener is in place, so as to provide only limited access to users unauthorized to access the base area.

In embodiments, the moving portion may be configured to be attached to the base portion by a connection such that the moving portion is structurally configured to move relative to the base portion while remaining attached to the base portion.

In embodiments, the cable access terminal may further comprise a fastener that may be structurally configured to secure the moving portion to the base portion in the closed position.

In embodiments, the moving portion may be structurally configured to pivot between an open position and the closed position.

In embodiments, the moving portion may be structurally configured to receive the adapter portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of a terminal in accordance with various aspects of the disclosure inside an enclosure.

FIG. 2 is a perspective view of the terminal of FIG. 1 in a tilted position inside an enclosure.

FIG. 3 is a perspective view of an access terminal of the terminal of FIG. 1 in a closed state.

FIG. 4 is a perspective view of the access terminal of FIG. 3 in a tilted position.

FIG. 5 is a perspective view of the access terminal of FIG. 3 with a cover removed.

FIG. 6 is an exploded perspective view of the access terminal of FIG. 3.

FIG. 7 is an exploded perspective view of an alternate embodiment of the access terminal of FIG. 3.

FIG. 8 is a perspective view of the access terminal of FIG. 3 in a tilted position.

### DETAILED DESCRIPTION OF EMBODIMENTS

Embodiments provide an access terminal having a pivoting portion that is structurally configured to permit access to a first side of an adapter portion and to a base area when a fastener is removed and to prevent access to the first side of the adapter portion and to the base area, while permitting access to a second side of the adapter portion, when the fastener is in place so as to provide only limited access to users unauthorized to access a component in the base area.

Embodiments of the disclosure provide a compact cable access terminal that provides access to components such as, for example, cable lugs, cable spooling, other cable management, splitting, and splicing areas when a security fastener is removed, and limits access to only one side of the adapters when the security fastener is in place, thereby providing only limited access to users unauthorized to access the cable lugs, cable spooling, other cable management, splitting, and splicing areas.

Embodiments provide a mini access terminal that is a compact fiber management system with splicing, splitter, and patching options. Embodiments can be used as a stand-alone, wall mounted, distribution terminal, and can be mounted inside a distribution box or enclosure. In embodiments, the terminal has two main parts; a cable holding/spooling area, and a module part that accommodates splicing, splitting, and/or patching.

Embodiments can be a replacement for optical distribution/termination boxes which are used in indoor applications. This is a very cost effective solution. It can be used as a fiber management system inside an optical distribution box or enclosure, as well as a stand-alone product as an indoor distribution terminal. The ability to be used in both types of applications reduces the number of different products needed in inventory.

Embodiments include a dedicated bottom compartment such as, for example, a spooling area, and a swing module that swings between a closed position above the bottom compartment to an open position that provides access to the bottom compartment. In embodiments, the swing module supports 24 fiber splicing, holding, and routing provisions in the bottom compartment and splitter holding provision and adaptors in an upper compartment. Both compartments are covered with lids. A top cover, once closed, prevents access to both the upper compartment and the bottom compartment. Embodiments include a special screw or other fastener to secure the top cover to the base of the terminal. Embodiments use a Torx screw, a pin Torx screw, a proprietary screw, or some other fastener that requires a tool that is not commonly possessed by users that should not be provided access to the splicing/splitter compartment and spooling area.

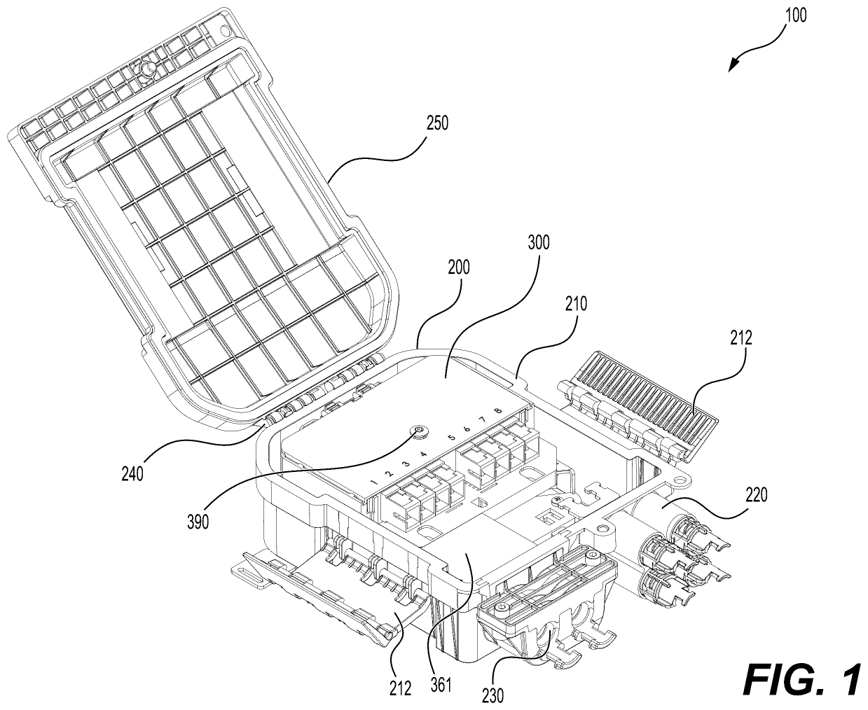

FIG. 1 shows an exemplary assembly 100 including an enclosure 200 and an exemplary access portion, for example, an access terminal, 300 in accordance with embodiments of the disclosure. The enclosure 200 has, in this example, a lower enclosure portion, for example, a base portion, for example, a base, 210 and an upper enclosure portion, for example, a cover portion, for example, a cover, 250. In this example, the cover 250 is attached to the base 210 by one or more hinges 240. In other examples, the cover 250 is attached to the base 210 by a friction fit or other mechanism. In this example, one or more securing portions, for example, friction snaps, 212 secure the cover 250 to the base 210 in a closed position. In this example, the base 210 has a plurality of cable receiving portions, for example, ports, 220, 230 that provide points for cables to enter and exit the enclosure 200.

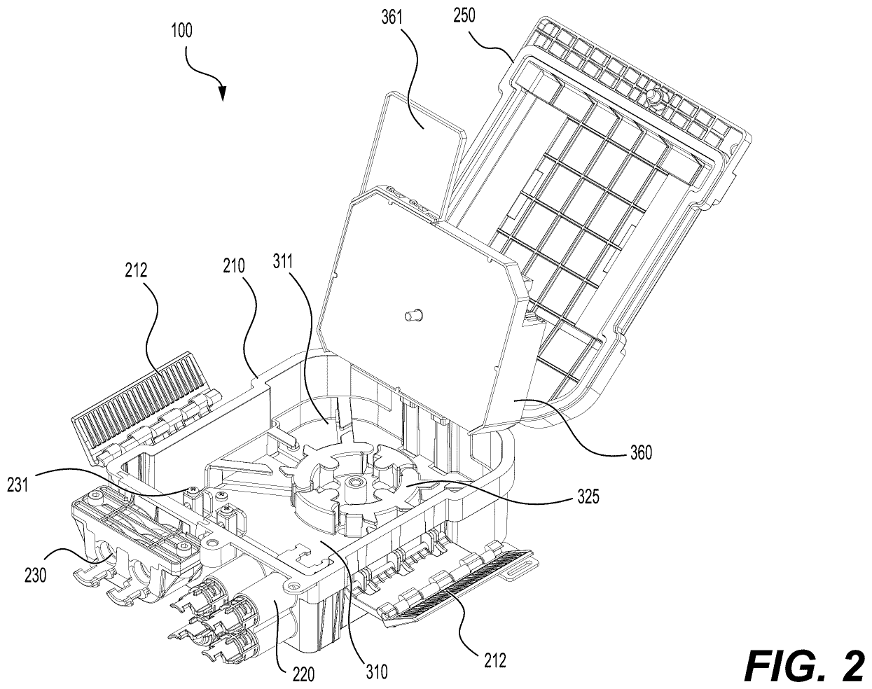

FIG. 2 shows a moving portion, for example, a pivoting portion, 360 of the access terminal 300 in a pivoted or open position relative to a base portion, for example, a fixed base portion, for example, a base, 310 of the access terminal 300. In this open position, a technician can access an area, for example, a base area, 311 that is below the pivoting portion 360 when the pivoting portion 360 is in a closed position (as shown in FIG. 1). FIG. 2 shows a cable management portion, for example, a cable management structure, for example, a spool, 325 on the base 310. The cable management structure 325 can be used to spool optical fibers, for example, in the access terminal 300. Also shown in FIG. 2 are one or more, in this example, two, cable securing portions, for examples, lugs, 231 for securing cables entering the enclosure 200. The example shown in FIG. 2 includes a cable securing portion covering portion, for example, a lug cover, 361 that is attached to, and pivots with, the pivoting portion 360. As shown in FIG. 1, the lug cover 361 covers the lugs 231 to prevent unauthorized access to the lugs 231 when the pivoting portion 360 is secured in the closed position shown in FIG. 1. By pivoting with the pivoting portion 360, the lug cover 361 is moved to a position that provides access to the lugs 231 when the pivoting portion 360 is moved to the open position. In this example, the pivoting portion 360 is secured in the closed position by a pivoting portion fastening portion, for example, a fastener (such as a Torx screw, a pin Torx screw, a proprietary screw, or some other fastener that requires a tool that is not commonly possessed), 390. Unauthorized access to the area 311 below the pivoting portion 360 is prevented or hindered by securing the pivoting portion 360 in the closed position by a fastener that requires a tool that is not commonly possessed.

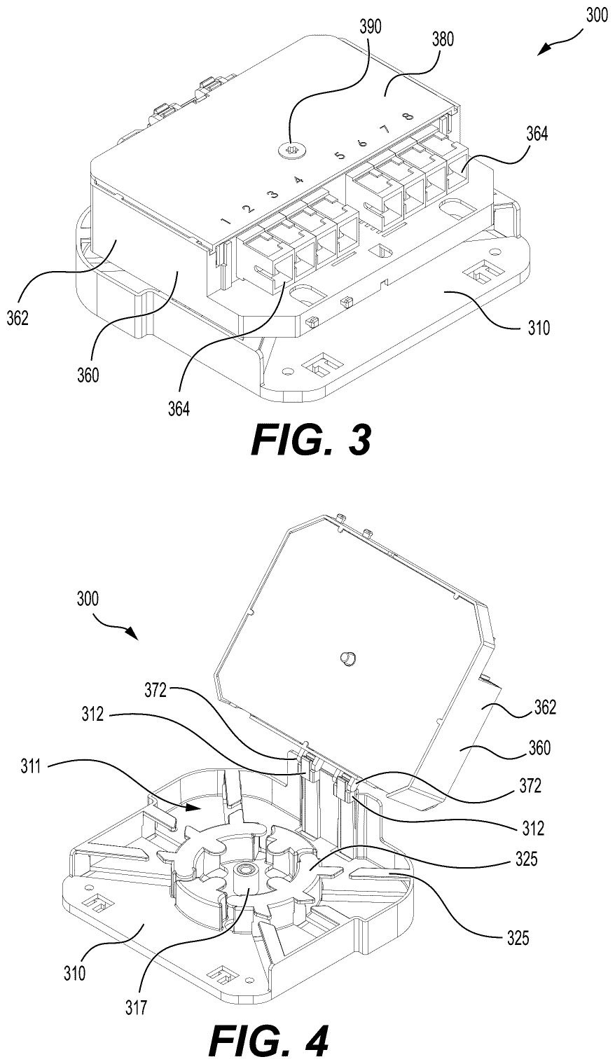

FIG. 3 shows an example of the access terminal 300 outside of the enclosure 200. FIG. 3 shows two sets of four adapter portions, for example, adapters, 364 such as, for example, SC adapters. In this example, the adapters 364 are mounted to an adapter receiving portion, for example, an adapter plate, 363 (see FIG. 6) that is attached to, or integrally formed in, the pivoting portion 360. As can be seen from FIGS. 1 and 3, access to, for example, a second side of the adapters 364 is provided with the pivoting portion 360 in the closed position. FIG. 3 shows a moving portion upper cover portion, for example, a pivoting portion upper cover portion, for example, a pivoting portion upper cover, 380 that is secured to a moving portion main portion, for example, a pivoting portion main portion, 362 of the pivoting portion 360 by the fastener 390. As a result, the access terminal 300 provides access to the second side of the adapters 364 (but not to a first side of the adapters) in the closed position, but prohibits access to other areas of the access terminal with the pivoting portion 360 in the closed position.

FIG. 4 shows the pivoting portion 360 in the open position, which provides access to the area 311 in the base 310. FIG. 4 shows moving portion attachment portions, for example, pivoting portion attachment portions, 372 that project from the pivoting portion 360 and engage receiving portions 312 on the base 310 to form hinges, or hinge portions, that allow the pivoting portion 360 to move, or pivot, between the open position and the closed position while remaining attached to the base 310.

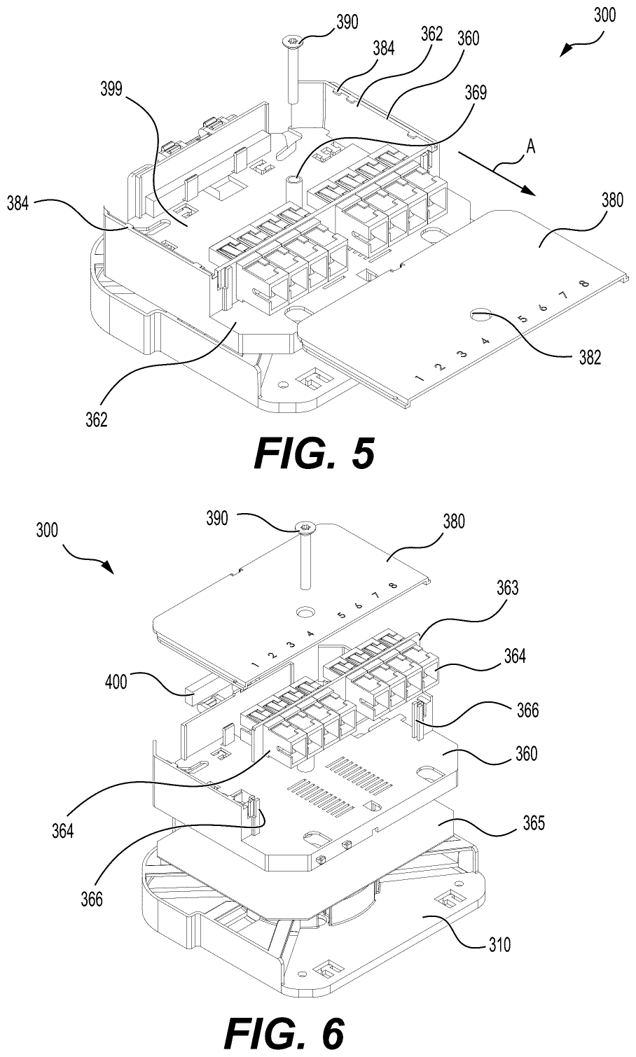

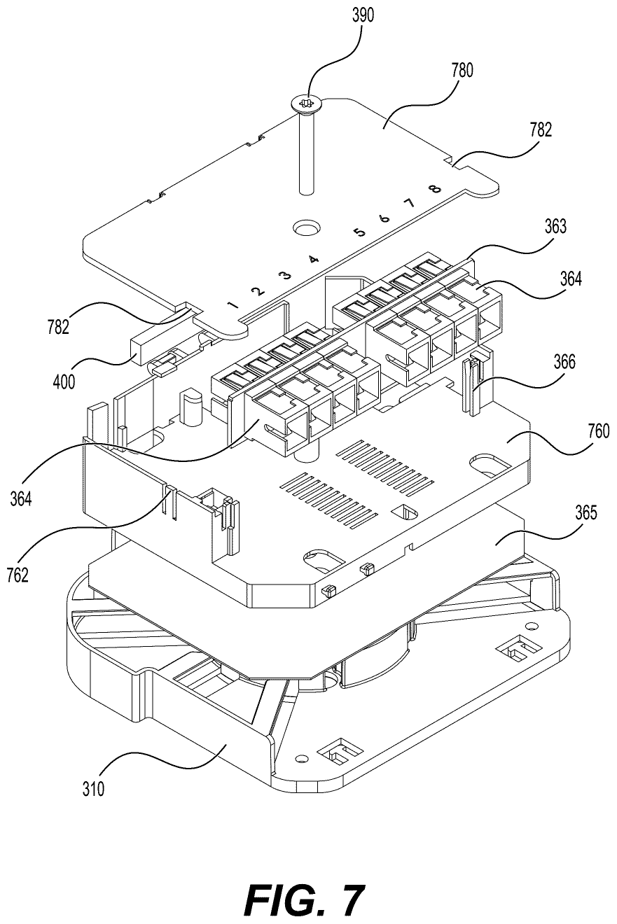

FIG. 5 shows the pivoting portion upper cover 380 removed from the main portion 362 of the pivoting portion 360. In this example, the pivoting portion upper cover 380 engages with the pivoting portion main portion 362 in a sliding arrangement such that the pivoting portion upper cover 380 is moved in the direction of arrow A to disengage the pivoting portion upper cover 380 from engagement tabs 384 on the pivoting portion main portion 362. In this example, the pivoting portion upper cover 380 includes a fastener receiving portion (such as, for example, a hole) 382 that is configured to receive the fastener 390. A receptacle (such as, for example, a cylindrical post) 369 is provided on the pivoting portion main portion 362 as a passageway for the fastener 390 to penetrate the pivoting portion main portion 362 so that it can engage an engagement portion (such as, for example, a threaded hole) 317 in the base 310 (see FIGS. 4 and 7). Also shown in FIG. 5 is an area (such as, for example, a splitter area) 399 that is, in this example, configured to receive a splitter (such as, for example, an optical fiber splitter).

FIG. 6 shows the access terminal 300 in an exploded view. In this example, the adapter plate 363 is held in a removable, slidable manner by slots 366 in the pivoting portion main portion 362. As shown in FIG. 3, the adapter plate cannot be removed from the pivoting portion main portion 362 when the pivoting portion upper cover 380 is in place. As shown in FIG. 3, in embodiments, access to the rear side (first side) of the adapters 364 is prevented by the pivoting portion upper cover 380. Also shown in FIG. 6 is a pivoting portion lower cover portion, for example a pivoting portion lower cover, 365 that attaches to an underside of the pivoting portion main portion 362 (described in more detail below).

FIG. 7 shows an alternate embodiment having a moving portion upper cover portion, for example, a pivoting portion upper cover portion, for example, a pivoting portion upper cover, 780 that clips into position on the pivoting portion 360 as opposed to the sliding engagement of pivoting portion upper cover 380. In the example shown in FIG. 7, one or more pivoting portion upper cover portion engagement portions, for example, engagement tabs, 762 formed on a pivoting portion 760 engage one or more pivoting portion engagement portions, for example, notches, 782 on the pivoting portion upper cover portion 780.

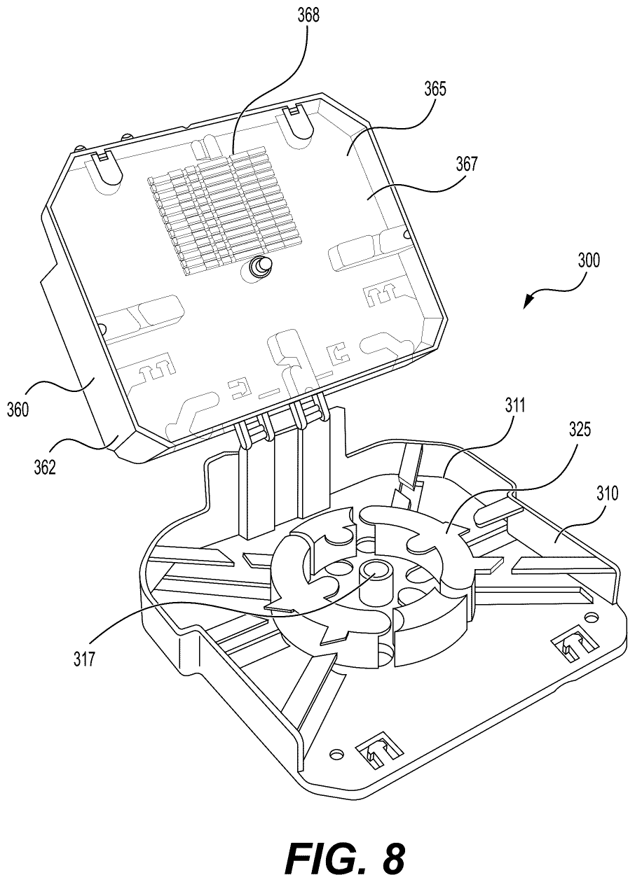

FIG. 8 shows the pivoting portion 360 in the open position, providing access to the area 311 of the base 310. The example shown in FIG. 8 has an optional fiber splice holder 368 that is configured to hold fiber splices. In this example, the pivoting portion lower cover 365 is transparent so that it allows the splice holder 368 to be seen by a technician while also protecting the fibers and the splices.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable access terminal comprising:
a base portion configured to define a base area;
a pivoting portion structurally configured to be attached to the base portion by a hinge portion such that the pivoting portion is structurally configured to pivot relative to the base portion while remaining attached to the base portion;
a fastener that is structurally configured to secure the pivoting portion to the base portion in a closed position;
a pivoting portion upper cover portion that is structurally configured to prevent access to an upper area of the pivoting portion;
wherein the pivoting portion is structurally configured to pivot between an open position and the closed position;
wherein the pivoting portion is structurally configured to prevent access to the base area in the closed position;
wherein the pivoting portion is structurally configured to receive an adapter portion;
wherein the pivoting portion upper cover portion is structurally configured to prevent access to a first side of the adapter portion as a result of the pivoting portion upper cover portion being secured to the pivoting portion by the fastener; and
wherein the pivoting portion is structurally configured to permit access to the first side of the adapter portion and to the base area when the fastener is removed and to prevent access to the first side of the adapter portion and to the base area, while permitting access to the second side of the adapter portion, when the fastener is in place so as to provide only limited access to users unauthorized to access a component in the base area.

2. The cable access terminal of claim 1, wherein the pivoting portion upper cover portion is configured to slidingly engage the pivoting portion.

3. The cable access terminal of claim 1, wherein the pivoting portion is structurally configured to receive an adapter plate, the adapter plate is configured to receive the adapter portion, and the adapter portion is configured to receive an optical fiber connector.

4. The cable access terminal of claim 1, wherein the upper area is structurally configured to receive a splitter.

5. The cable access terminal of claim 4, wherein the splitter comprises an optical fiber splitter.

6. The cable access terminal of claim 1, wherein the cable access terminal further comprises a cable securing portion covering portion that is configured to extend from the pivoting portion and cover a cable securing portion located adjacent the cable access terminal.

7. The cable access terminal of claim 1, wherein the lower side of the pivoting portion comprises a splice holder.

8. The cable access terminal of claim 7, wherein the cable access terminal further comprises a pivoting portion lower cover portion that is structurally configured to cover a lower side of the pivoting portion, the lower side being opposite to the upper area.

9. The cable access terminal of claim 8, wherein the pivoting portion lower cover portion is configured to be transparent to provide visual inspection of the splice holder.

10. The cable access terminal of claim 1, wherein the base portion comprises cable management structure that is structurally configured to restrain a cable.

11. The cable access terminal of claim 10, wherein the pivoting portion is configured to prevent access to the cable management structure when the pivoting portion is in the closed position.

12. A cable access terminal comprising:
a base portion configured to define a base area;
a moving portion structurally configured to be attached to the base portion by a connection portion such that the moving portion is structurally configured to move relative to the base portion while remaining attached to the base portion;
a fastener that is structurally configured to secure the moving portion to the base portion in a closed position;
a moving portion upper cover portion that is structurally configured to prevent access to an upper area of the moving portion;
wherein the moving portion is structurally configured to prevent access to the base area in the closed position;
wherein the moving portion upper cover portion is structurally configured to prevent access to a first side of an adapter portion as a result of the moving portion upper cover portion being secured to the moving portion by the fastener; and
wherein the moving portion is structurally configured to permit access to the first side of the adapter portion and to the base area when the fastener is removed and to prevent access to the first side of the adapter portion and to the base area, while permitting access to the second side of the adapter portion, when the fastener is in place, so as to provide only limited access to users unauthorized to access a component in the base area.

13. The cable access terminal of claim 12, wherein the moving portion is structurally configured to pivot between an open position and the closed position.

14. The cable access terminal of claim 12, wherein the moving portion is structurally configured to receive the adapter portion.

15. The cable access terminal of claim 12, wherein the moving portion is structurally configured to receive an adapter plate, the adapter plate is configured to receive the adapter portion, and the adapter portion is configured to receive an optical fiber connector.

16. The cable access terminal of claim 12, wherein the cable access terminal further comprises a cable securing portion covering portion that is configured to extend from the moving portion and cover a cable securing portion located adjacent the cable access terminal.

17. A cable access terminal comprising:
a base portion;
a moving portion structurally configured to be movingly attached to the base portion;
a moving portion upper cover portion that is structurally configured to prevent access to an upper area of the moving portion;
wherein the moving portion is structurally configured to prevent access to a base area in a closed position;
wherein the moving portion upper cover portion is structurally configured to prevent access to a first side of an adapter portion as a result of the moving portion upper cover portion being secured to the moving portion; and
wherein the moving portion is structurally configured to permit access to the first side of the adapter portion and to the base area when the fastener is removed and to prevent access to the first side of the adapter portion and to the base area, while permitting access to the second side of the adapter portion, when the fastener is in place, so as to provide only limited access to users unauthorized to access the base area.

18. The cable access terminal of claim 17, wherein the moving portion is configured to be attached to the base portion by a connection such that the moving portion is structurally configured to move relative to the base portion while remaining attached to the base portion.

19. The cable access terminal of claim 17, wherein the cable access terminal further comprises a fastener that is structurally configured to secure the moving portion to the base portion in the closed position.

20. The cable access terminal of claim 17, wherein the moving portion is structurally configured to pivot between an open position and the closed position.

21. The cable access terminal of claim 17, wherein the moving portion is structurally configured to receive the adapter portion.
